(19) United States
(12) Patent Application Publication
(10) Pub. No.: US 2016/0236196 A1
(43) Pub. Date: Aug. 18, 2016

(54) Reagent Holding Container, Liquid Delivery Device, Reagent Discharge Method

(71) Applicant: HITACHI, LTD., Chiyoda-ku, Tokyo (JP)

(72) Inventors: Hisao INAMI, Tokyo (JP); Yoshihiro NAGAOKA, Tokyo (JP)

(21) Appl. No.: 15/023,192

(22) PCT Filed: Sep. 30, 2013
(86) PCT No.: PCT/JP2013/076466

§ 371 Date: Mar. 18, 2016

(51) Int. Cl. B01L 3/00

(52) U.S. Cl. CPC B01L 3/52; B01L 3/502; B01L 2300/044; B01L 2300/123; B01L 2300/0887; B01L 2200/12; B01L 2300/0672; B01L 2300/14; B01L 2200/16; B01L 2300/12

(57) ABSTRACT

A reagent holding container is provided that is capable of storing a reagent in a stable state over a long period of time and simply delivering a held reagent. A reagent holding container having a flexible material and a perforable material, wherein a plunger functions both to deform the flexible material of the reagent holding container and perforate the perforable material of the reagent holding container.

### TECHNICAL FIELD

The present invention relates to a reagent holding container for storing a reagent, a liquid delivery device provided with the reagent holding container, and a reagent discharge method for discharging a reagent from the reagent holding container.

### BACKGROUND ART

A technique concerning a reagent holding container of related art is described in PTL 1. This publication describes a reagent holding container that includes a deformable upper structure and a pierceable bottom structure. In this publication, a piercing element provided below the pierceable bottom structure is pushed upward with a plunger to pierce the bottom structure while bending the deformable upper portion under the applied pressure of a plunger to discharge the reagent contained in the container. The precondition of this technique is that the plungers and the reagent are avoided from contact to prevent plunger contamination.

PTL 2 also describes a technique concerning a reagent holding container of related art. This publication describes drying and holding a reagent in a bellows-shaped reagent holding container, dissolving the dried reagent in a sample delivered to the reagent holding container, and crushing the bellows-shaped reagent holding container to deliver a sample and reagent mixture.

### CITATION LIST

### Patent Literature

PTL 1: JP-A-2013-064725

PTL 2: JP-A-2011-158463

### SUMMARY OF INVENTION

### Technical Problem

However, the technique disclosed in PTL 1 requires installing two plungers, one on the upper side of the reagent holding container to deform the upper portion of the container, and one on the lower side of the reagent holding container to pierce the bottom portion. This involves a complicated mechanism on. the liquid delivery device side where delivery of a reagent takes place. Another drawback is that the bottom piercing element installed adjacent the bottom portion of the reagent holding container poses the risk of piercing the bottom portion during the storage of the reagent holding container. The device of PTL 2 involves high manufacturing cost because the reagent is heated or vacuum. dried after being sealed in the reagent holding container. PTL 1 and PTL 2 also do not consider sealing a liquid reagent in the reagent holding container over extended time periods without causing the liquid to evaporate.

The present invention was completed under these circumstances, and it is an object of the present invention to provide a reagent holding container that enables a reagent held therein to be delivered using a simple mechanism, and stably storing a reagent over extended time periods.

### Solution to Problem

A reagent holding container of the present invention is a reagent holding container that includes a deformable member and a pierceable member. The reagent holding container discharges a reagent held therein upon an external pressure mechanism deforming the deformable member and piercing the pierceable member.

### Advantageous Effects of Invention

The present invention can provide a reagent holding container that enables a reagent held therein to be delivered using a simple mechanism, and stably storing a reagent over extended time periods.

Other objects, configurations, and advantages of the present invention will be more clearly understood from the descriptions of the embodiments below.

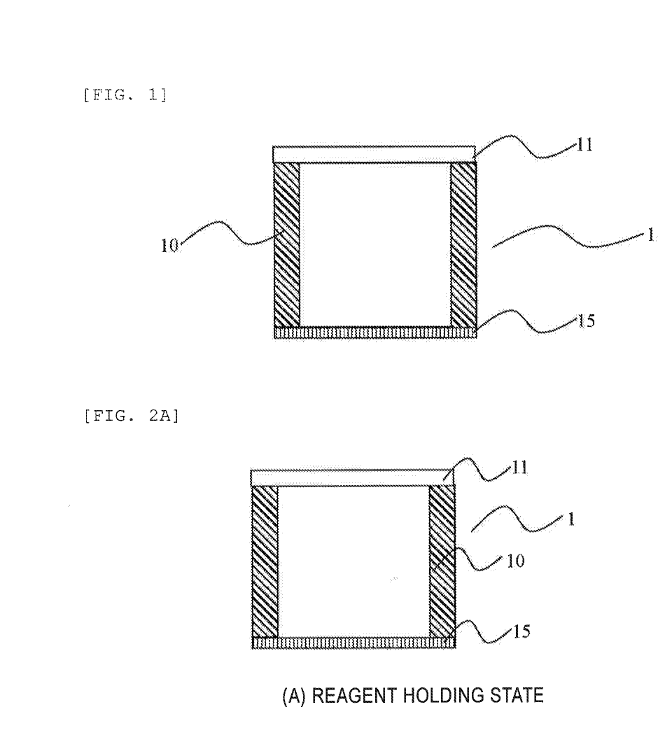

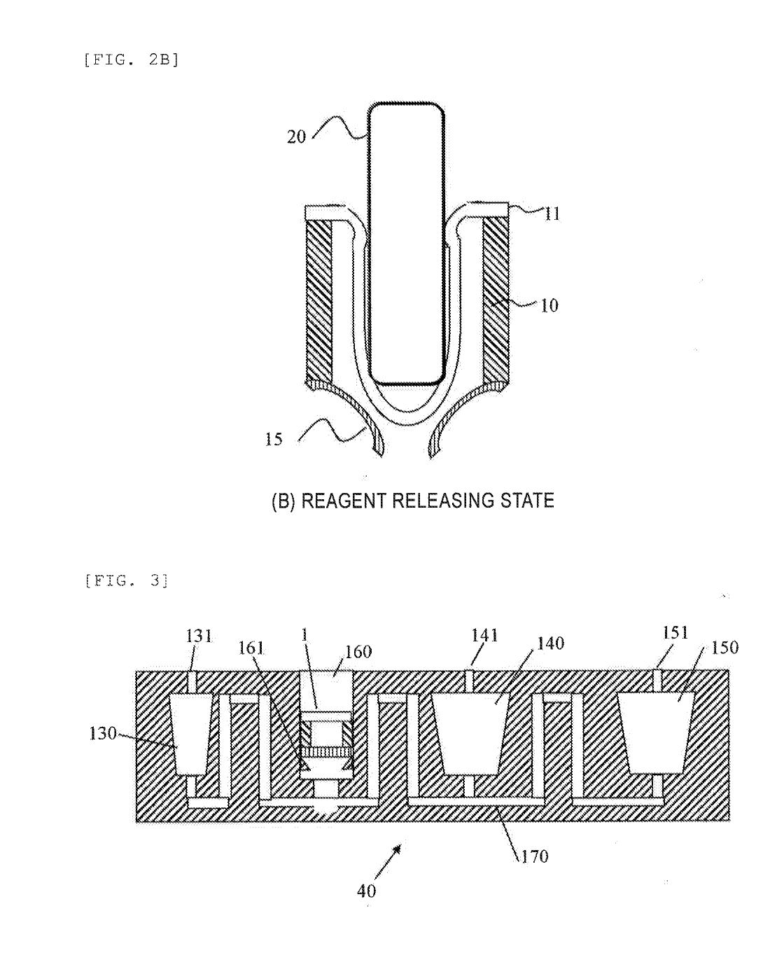

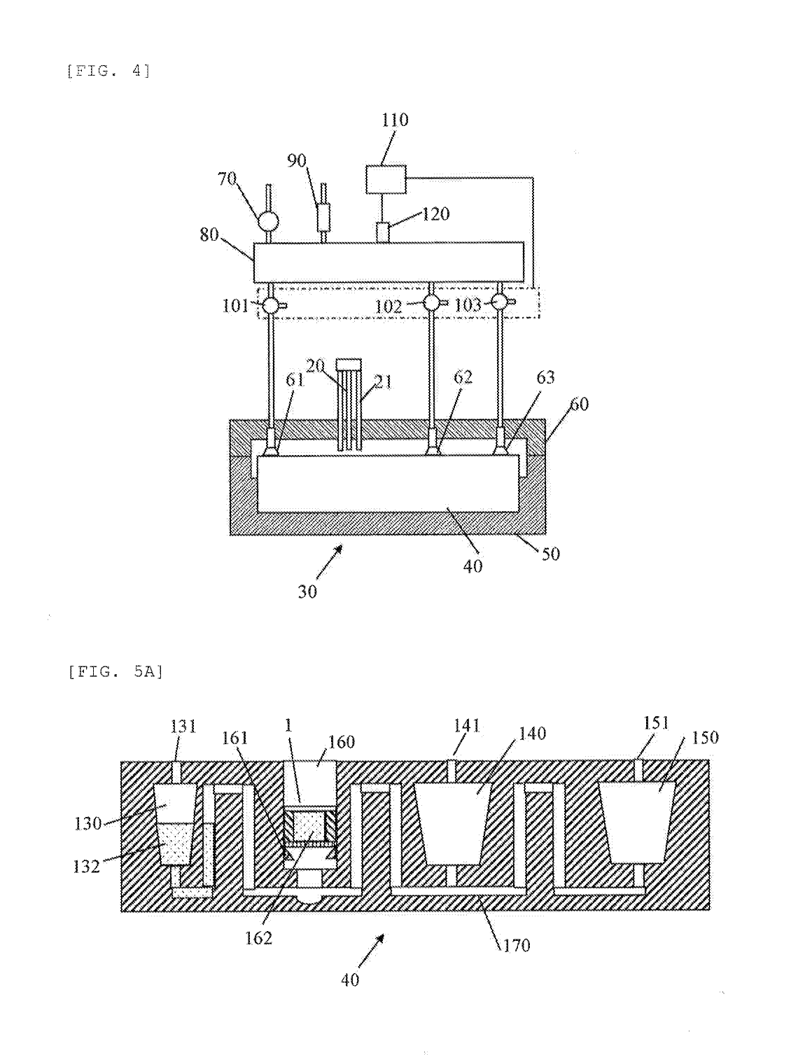

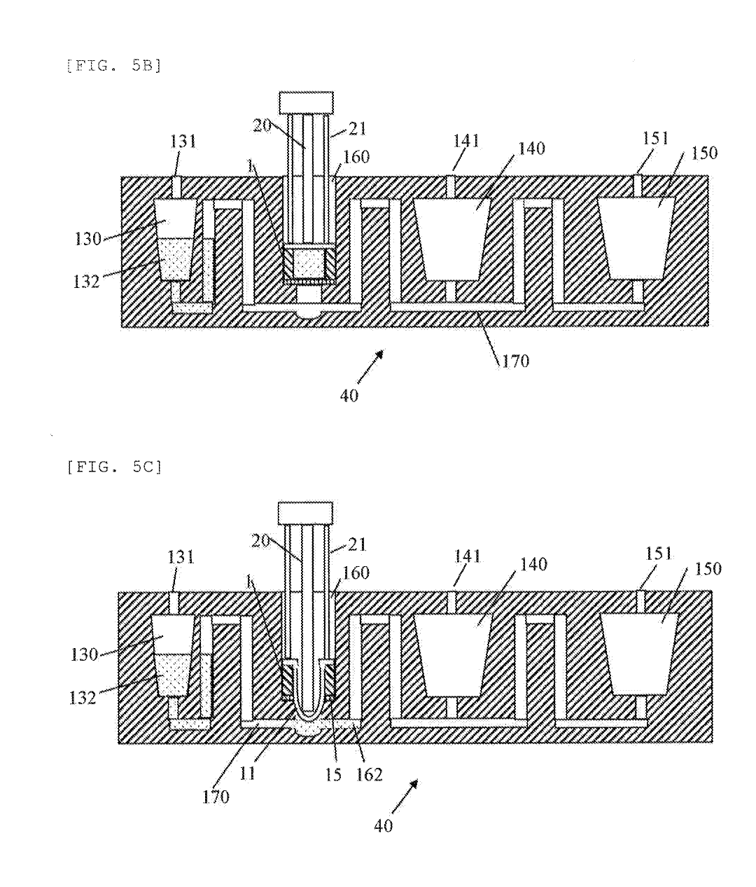

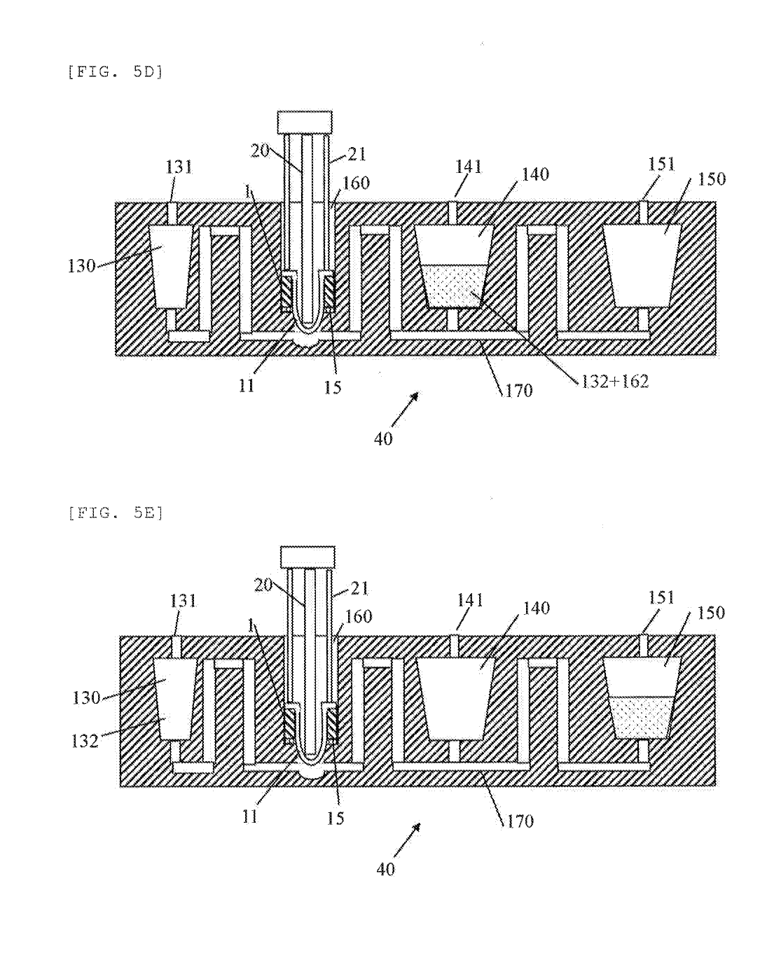

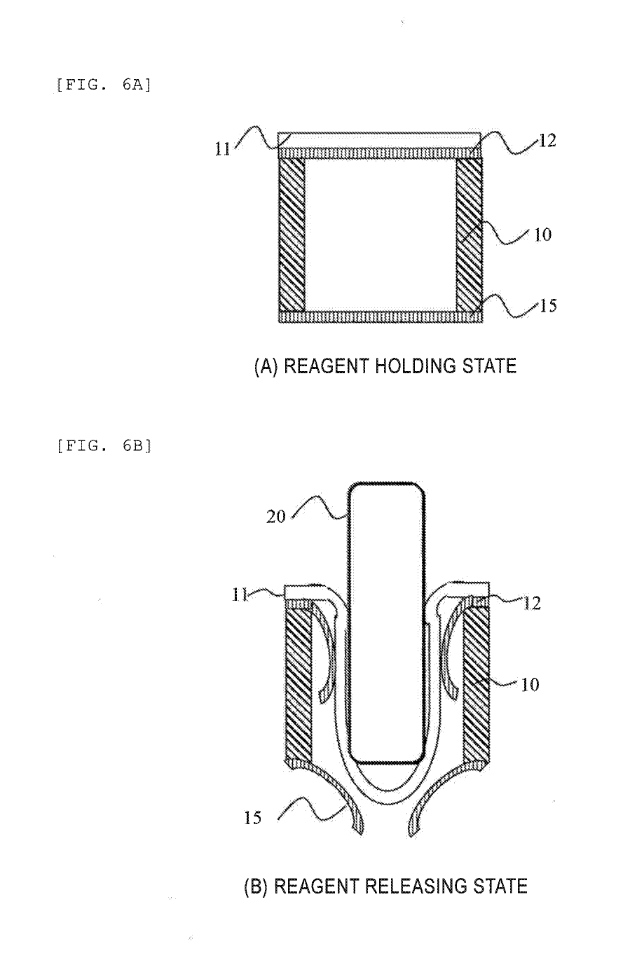

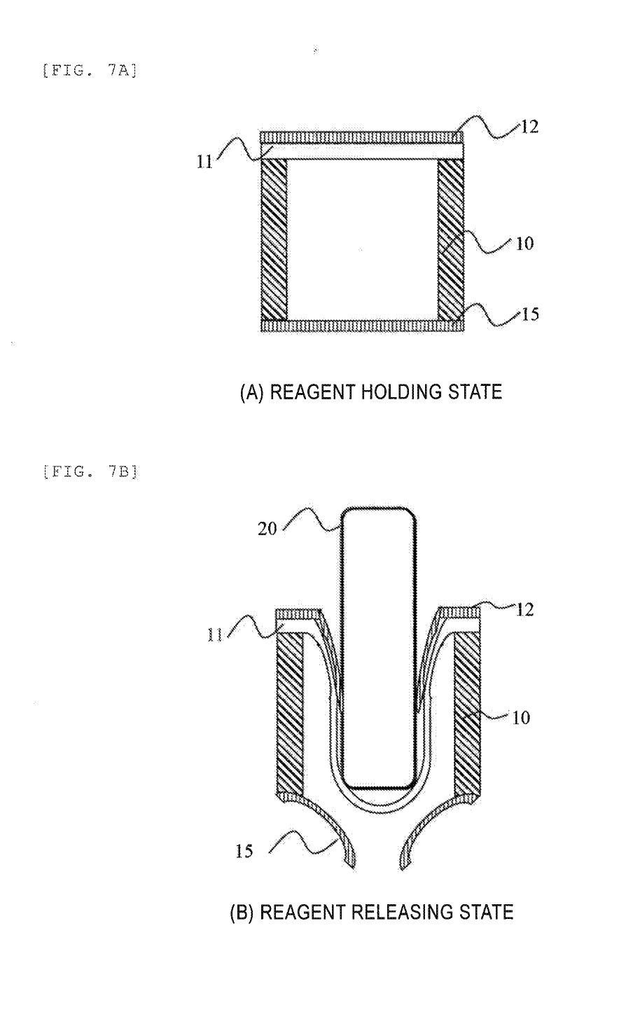

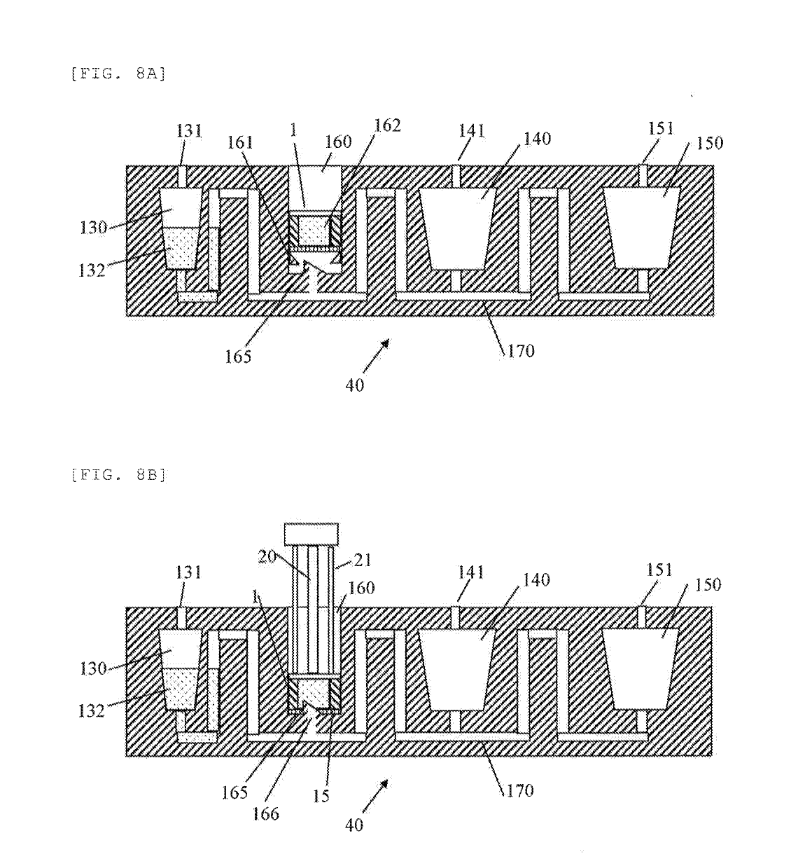

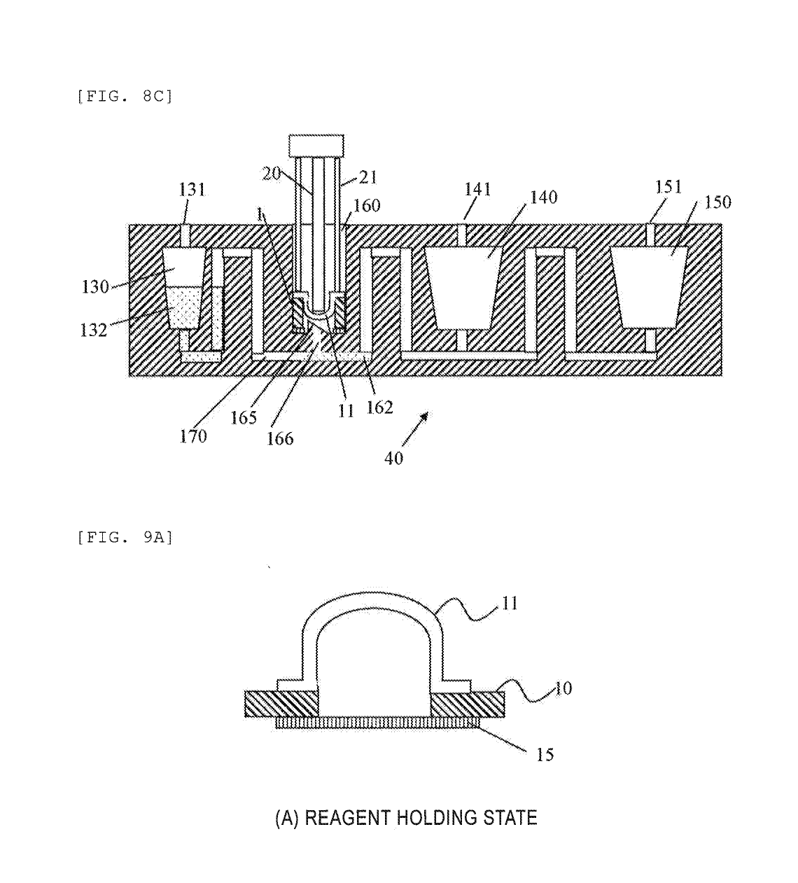

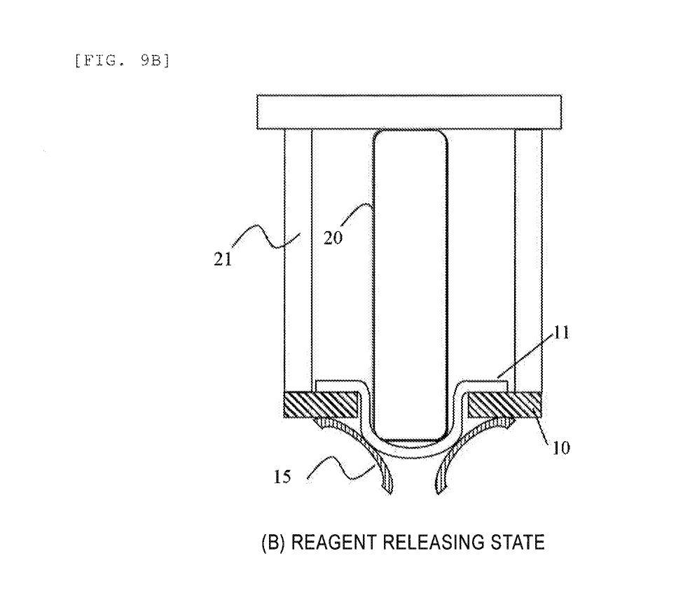

### BRIEF DESCRIPTION OF DRAWINGS

[FIG. 1] FIG. 1 is a cross sectional view of a reagent holding container according to First Embodiment

[FIG. 2A] FIG. 2A is a cross sectional view representing the operation of the reagent holding container.

[FIG. 2B] FIG. 2B is a cross sectional view representing the operation of the reagent holding container.

[FIG. 3] FIG. 3 is a side view of a liquid delivery device provided with the reagent holding container.

[FIG. 4] FIG. 4 is a block diagram of a sample processing apparatus using the liquid delivery device.

[FIG. 5A] FIG. 5A is a side view representing the operation of the sample processing apparatus.

[FIG. 5B] FIG. 5B is a side view representing the operation of the sample processing apparatus.

[FIG. 5C] FIG. 5C is a side view representing the operation of the sample processing apparatus.

[FIG. 5D] FIG. 5D is a side view representing the operation of the sample processing apparatus.

[FIG. 5E] FIG. 5E is a side view representing the operation of the sample processing apparatus.

[FIG. 6A] FIG. 6A is a cross sectional view representing the operation of a reagent holding container according to Second Embodiment.

[FIG. 6B] FIG. 6B is a cross sectional view representing the operation of the reagent holding container according to Second Embodiment.

[FIG. 7A] FIG. 7A is a cross sectional view representing the operation of a reagent holding container according to Third Embodiment.

[FIG. 7B] FIG. 7B is a cross sectional view representing the operation of the reagent holding container according to Third Embodiment.

[FIG. 8A] FIG. 8A is a side view representing the operation of a sample processing apparatus according to Fourth Embodiment

[FIG. 8B] FIG. 8B is a side view representing the operation of the sample processing apparatus according to Fourth Embodiment.

[FIG. 8C] FIG. 8C is a side view representing the operation of the sample processing apparatus according to Fourth Embodiment.

[FIG. 9A] FIG. 9A is a cross sectional view representing the operation of a reagent holding container according to Fifth Embodiment.

[FIG. 9B] FIG. 9B is a cross sectional view representing the operation of the reagent holding container according to Fifth Embodiment.

### DESCRIPTION OF EMBODIMENTS

Embodiments of the present invention are described below with reference to the accompanying drawings. The following embodiments are illustrative, and may be applied in other forms, including an embodiment based on a combination of different embodiments, and an embodiment based on a combination or replacements with known or common techniques.

### Example 1

FIGS. 1 and 2 illustrate a reagent holding container representing First Example. As shown in FIG. 1, a reagent container 1 is formed from a container base 10, a bendable container portion 11, and a pierceable container portion 15.

The material of the container base 10 is not particularly limited, and resin materials such as polystyrene, polypropylene, polycarbonate, and COP, and metallic materials such as aluminum, and stainless steel may be used. From the viewpoint of preventing evaporation of a reagent, it is preferable to use metallic materials such as aluminum and stainless steel. However, the same effect can be obtained by vapor depositing metal on resin material, or attaching a metal foil to resin material.

The bendable container portion 11 may use flexible deformable materials, such as natural rubber, isoprene rubber, butadiene rubber, styrene-butadiene rubber, butyl rubber, nitrile rubber, ethylene propylene rubber, chloroprene rubber, acryl rubber, urethane rubber, and silicone rubber. Preferred for use is silicone rubber, which has both tensile strength and impact resilience.

The pierceable container portion 15 may use an aluminum film, or a plastic film such as polypropylene, polyimide, polyester, nylon, polycarbonate, and PET. An aluminum film is preferred. for its ease of piercing, and the ability to prevent evaporation. A plastic film with vapor-deposited metal such as aluminum is more preferred because it generates less piercing debris.

The bond between the container base 10 and the bendable container portion 11, and between the container base 10 and the pierceable container portion 15 may be formed by thermocompression bonding or with a double-sided tape.

The operation of the reagent container 1 is described below using FIG. 2. FIG. 2(A) shows a state in which the reagent container 1 is sealed with the bendable container portion 11 and the pierceable container portion 15, with a reagent held inside the reagent container 1. Pressing the bendable container portion 11 with a plunger 20 causes the bendable container portion 11 to bend downward as shown in FIG. 2(B). As the plunger 20 is pressed down further, the pierceable container portion 15 breaks, and the reagent inside the reagent container 1 is released out of the reagent container 1.

Because the bendable container portion 11 is bent down in use, the bendable container portion 11 has a thickness of preferably 1 mm or less, desirably 0.5 mm or less when, for example, silicone rubber is used. On the other hand, the thickness should preferably be 0.1 mm or more to prevent breaking the silicon rubber upon being bent.

For ease of breakage, the pierceable container portion 15 has a thickness of preferably 10 to 50 μm when, for example, an aluminum film is used. A thickness below 10 μm is not preferable because such a thin film is susceptible to cracking and easily breaks, and is not suited for storing reagent.

The following describes a liquid delivery device with the reagent container 1 installed therein. FIG. 3 is a detailed explanatory diagram of a liquid delivery device of the present invention. FIG. 4 is a block diagram of a sample processing apparatus using the liquid delivery device.

The configuration of the sample processing apparatus shown in FIG. 4 is described first. A sample processing apparatus 30 is configured form a device mount 50 in which a liquid delivery device 40 is installed, and a top lid 60 that holds the liquid delivery device 40, and seals the sample processing apparatus 30.

The liquid delivery device 40 has a top surface with air ports (described later), and the top lid 60 has air connectors 61, 62, and 63 hat allow passage of air through the ports.

The air connectors 61, 62, 63 contact the corresponding air ports on the top surface of the liquid delivery device 40 upon installing the liquid delivery device 40 on the device mount 50, and sealing the sample processing apparatus 30 with the top lid 60 by bringing it into contact with the device mount 50. This enables high pressure air to be guided into the liquid delivery device. The high pressure air generated in a pump 70 is held in an air chamber 80, and adjusted to an almost constant pressure with a regulator 90. The air adjusted to a constant pressure in the air chamber 80 is piped to the air connectors 61, 62, 63 via valves 101, 102, and 103, respectively.

The valves 101, 102, and 103 are controlled by a controller 110, which selects the valves 101, 102, and 103 to supply air to the air connectors 61, 62, 63 from the air chamber 80, or release air to the atmosphere through the air connectors 61, 62, 63, or closes all the valves 101, 102, and 103.

A pressure sensor 120 for measuring the pressure inside the air chamber 80 is provided, as required. The controller 110 controls the valves 101, 102, and 103 according to signals from the pressure sensor 120.

The liquid delivery device 40 is described below in detail. FIG. 3 is a side view of the liquid delivery device 40.

As shown in the side view, the liquid delivery device 40 As configured form a sample tank 130, a reagent tank 160, a mixture tank 140, a sampling tank 150, and a channel 170. The air ports (131, 141, and 151 in the diagram) are disposed at the upper portions of the sample tank 130, the mixture tank 140, and the sampling tank 150. The air ports 131, 141, 151 are provided at positions that contact the air connectors 61, 62, 63 shown in FIG. 4. The air thus enters the air ports 131, 141, 151 through the air connectors 61, 62, 63 via the valves 101, 102, and 103. In the reagent tank 160 is disposed a stop 161 that holds the reagent container 1.

Referring to FIG. 5, the following describes how a sample and a reagent are mixed in the liquid delivery device 40.

FIG. 5A shows an initial, state in which a sample 132 has been injected into the sample tank 130 through the air port 131. A reagent 162 is contained in the reagent container 1 installed in the reagent tank 160. The mixture tank 140, the sampling tank 150, and the channel 170 are filled with air. The valves 101, 102, and 103 (see FIG. 4) are all closed.

FIG. 5B shows a state in which a plunger guide 21 (see FIG. 4) is inserted into the reagent tank 160, and the reagent container 1 is pressed against the Liquid delivery device 40. With the plunger guide 21 held in this state, the reagent container 1 becomes tightly coupled to the liquid delivery device 40. This makes it possible to prevent liquid leakage from the channel 170 to the reagent tank 160.

FIG. 5C shows a state in which the plunger 20 (see FIG. 4) is inserted into the reagent tank 160, and bending the bendable container portion 11 of the reagent container 1 downward, and piercing the pierceable container portion 15. The channel 170 may be depressed in a portion directly below the reagent tank 160 as shown in the diagram so that the plunger 20 can fully discharge the reagent 162 inside the reagent container 1. By opening the valve 102, the air inside the channel 170 is released into the air port 141, and the reagent 162 inside the reagent container 1 is sent to inside the channel 170 toward the mixture tank 140.

FIG. 5D shows a state in which the valve 101 is opened to supply air into the sample tank 130 through the air port 131, and deliver the sample 132 inside the sample tank 130 and the reagent 162 in the channel 170 to the mixture tank 140. Here, the sample 132 and the reagent 162 can be prevented from finding their way to the sampling tank 150 by opening the valve 103 and supplying air to the sampling tank 150 through the air port 151. The sample 132 and the reagent 162 inside the mixture tank 140 become mixed by bubbling with air supplied to the mixture tank 140 through the air ports 131 to 151.

FIG. 5E shows a state in which the valve 102 is opened to supply air through the air port 132, and deliver the mixture of the sample 132 and the reagent 162 in the mixture tank 140 to the sampling tank 150. Here, the sample 132 and the reagent 162 can be prevented from finding their way to the sample tank 130 by opening the valve 101 and supplying air to the sample tank 130 via the air port 131. Finally, all valves are closed. to finish the liquid delivery operation.

As described above, the present invention simplifies the mechanism on the liquid delivery device side with the dual function of the plunger deforming the flexible material of the reagent holding container, and piercing the pierceable material of the reagent holding container. Because the reagent container, the plunger (piercing mechanism), and the channel are distant away from each other in the initial state, there is no risk of the reagent container being pierced during the storage of the liquid delivery device, and liquid leakage can be prevented.

### Example 2

FIG. 6 represents another example of the present invention. This example does not differ from Example 1 with respect to the reagent container formed from the container base, the bendable container portion, and the pierceable container portion, but differs from Example 1 in the configuration that more actively prevents evaporation of reagent through the bendable container portion.

FIG. 6 represents a reagent holding container of Second Example. As shown in FIG. 6, the reagent container 1 is formed from a container base 10, a bendable container portion 11, and pierceable container portions 12 and 15.

The container base 10, the bendable container portion 11, and the pierceable container portions 12 and 15 are made of the same materials used in Example 1. The feature of Example 2 lies in the double structure of the bendable container portion 11 and the pierceable container portion 12 in one of the sealing surfaces of the container base 10. The most preferred material for the pierceable container portion 12 is an aluminum film for its ease of piercing, and the ability to prevent evaporation, as described in Example 1. The aluminum film used for the pierceable container portion 12 is more inert to the reagent than the rubber materials used for the bendable container portion 11. Second Example using an aluminum film for the pierceable container portion can thus be said as being suited in situations where the reagent is corrosive to the rubber material of the bendable container portion 11. instead of layering the pierceable container portion 12 on the bendable container portion 11, aluminum or other such metal may be vapor deposited on the bendable container portion 11 to make a configuration without the pierceable container portion 12.

The bond between the container base 10 and the pierceable container portion 12, and between the pierceable container portion 12 and the bendable container portion 11 may be formed by thermocompression bonding, or with a double-sided tape.

The operation of the reagent container 1 is described below using FIG. 6. FIG. 6(A) shows a state in which the reagent container 1 is sealed with the bendable container portion 11 and the pierceable container portion 12, and the pierceable container portion 15, with a reagent held inside the reagent container 1. Pressing the bendable container portion 11 with the plunger 20 bends the bendable container portion 11 downward as shown in FIG. 6(B), and pierces the pierceable container portion 12. As the plunger 20 is pressed down further, the pierceable container portion 15 breaks, and the reagent inside the reagent container 1 is released out of the reagent container 1.

With the same basic structure described, in Example 1, Second Example can be said as a convenient liquid delivery method that enables discharge of a reagent with the single plunger. The double structure of the bendable container portion and the pierceable container portion can provide chemical resistance while preventing reagent evaporation.

### Example 3

FIG. 7 represents another example of the present invention. This example does not differ from Example 2 with respect to the double structure of the bendable container portion and the pierceable container portion in one of the sealing surfaces of the container base, but differs from Example 2 in the configuration that prevents the piercing debris of the pierceable container portion from entering the channel.

FIG. 7 represents the reagent holding container of Third Example. As shown in FIG. 7, the reagent container 1 is formed from a container base 10, a bendable container portion 11, and pierceable container portions 12 and 15.

The container base 10, the bendable container portion 11, and the pierceable container portions 12 and 15 are made of the same materials used in Examples 1 and 2. The feature of Example 3 is that the double structure of the bendable container portion 11 and the pierceable container portion 12 in one of the sealing surfaces of the container base 10 contacts the container base 10 on the side of the bendable container portion 11. The material of the bendable container portion 11 is preferably rubber material, as described in Example 1. The present example is thus effective when the reagent stored in the reagent container 1 is inert to the rubber material of the bendable container portion 11. Instead of layering the bendable container portion 11 on the pierceable container portion 12, aluminum or other such metal may be vapor deposited on the side of the bendable container portion 11 opposite the reagent contacting surface to make a configuration without the pierceable container portion 12.

The operation of the reagent container 1 is described below using FIG. 7. FIG. 7(A) shows a state in which the reagent container 1 is sealed with the bendable container portion 11 and the pierceable container portion 12, and the pierceable container portion 15, with a reagent held inside the reagent container 1. Pressing the bendable container portion 11 with the plunger 20 pierces the pierceable container portion 12, and bends the bendable container portion 11 downward as shown in FIG. 7(B). As the plunger 20 is pressed down further, the pierceable container portion 15 breaks, and the reagent inside the reagent container 1 is released out of the reagent container 1.

With the same basic structure described in Examples 1 and 2, Third Example can be said as a convenient liquid delivery method that enables discharge of a reagent with the single plunger. An advantage of the bendable container portion contacting the container base in the double structure of the bendable container portion and the pierceable container portion in one of the sealing surfaces of the container base is that debris can be prevented from entering the channel upon piercing the pierceable container portion, and that the reagent is unlikely to remain in the reagent container.

### Example 4

### Piercing with Channel Projection

FIG. 8 represents another example of the present invention. This Example differs from Example 1 in that the bendable container portion is deformed with the plunger whereas the pierceable container portion is pierced with a projection from the channel side (the projection having, a channel therein).

Referring to FIG. 8, the following describes how the reagent is delivered in Example 4. FIG. 8A shows an initial state in which the reagent container 1 held in the reagent tank 160 with a stop 161 is storing a reagent 162 without touching a reagent tank projection 165 provided at the bottom portion of the reagent tank 160.

FIG. 8B shows a state in which the plunger guide 21 (see FIG. 4) is inserted in the reagent tank 160, and the reagent container 1 is pressed against the liquid delivery device 40. Here, the pierceable container portion 15 of the reagent container 1 (see FIG. 2) is pierced by the reagent tank projection 165. With the plunger guide 21 held in this state, the reagent container 1 becomes tightly coupled to the liquid delivery device 40. This makes it possible to prevent liquid leakage from the channel 170 to the reagent tank 160.

FIG. 8C shows a state in which the plunger 20 (see FIG. 4) is inserted in the reagent tank 160, and pressing down the bendable container portion 11 (see FIG. 2) of the reagent container 1. In response, the reagent 162 inside the reagent container 1 flows into the channel 170 via a projection channel 166.

As described above, the difference from Example 1 is that the deformation of the bendable container portion, and the piercing of the pierceable container portion are separately performed. By making the inner diameter of the projection channel 166 smaller, the dead volume between the reagent container 1 and the liquid delivery device 40 can be reduced to prevent the reagent from remaining in the reagent container 1.

### Example 5

FIG. 9 represents another example of the present invention. This Example differs from the other examples in that the bendable container portion is raised upward in the initial state.

The operation of the reagent container 1 of Example 5 is described below using FIG. 9. FIG. 9(A) shows a state in which the reagent container 1 is sealed with the bendable container portion 11 and the pierceable container portion 15, with the reagent held inside the reagent container 1. The plunger guide 21 presses the peripheries of the container base 10 against the liquid delivery device 40 (the liquid delivery device 40 is not shown). Pressing the bendable container portion 11 with the plunger 20 bends the bendable container portion 11 downward, and the pierceable container portion 15 breaks as the plunger 20 is pressed down further, releasing the reagent inside the reagent container 1 out of the reagent container 1.

The bendable container portion and the pierceable container portion are not necessarily required to have flat surfaces, provided that there is a portion (the container base in this example) that can be pressed against the liquid delivery device with the plunger guide as in this example.

The present invention is not limited to the examples described above, and includes various modifications. For example, the foregoing detailed descriptions of the examples above are given to facilitate understanding of the present invention, and are not necessarily limited to an embodiment that includes all the configurations described above. Some of the configurations of any of the examples may be replaced with the configurations of other examples, or the configurations of any of the examples may be added to the configurations of other examples. Additions, deletions, or replacements of some of the configurations of examples are also possible.

### REFERENCE SIGNS LIST

1 Reagent container

10 Container base

11 Bendable container portion

12, 15 Pierceable container portion

20 Plunger

21 Plunger guide

30 Sample processing apparatus

40 Liquid delivery device

50 Device mount

60 Top lid

61, 62, 63 Air connectors

70 Pump

80 Air chamber

90 Regulator

101, 102, 103 Valves

110 Controller

120 Pressure sensor

130 Sample tank

131, 141, 151 Air ports

132 Sample

140 Mixture tank

150 Sampling tank

160 Reagent tank

161 Stop

162 Reagent

165 Reagent tank projection

166 Projection channel

170 Channel

1. A reagent holding container comprising a deformable member and a pierceable member,
wherein reagent holding container discharges a reagent held therein upon an external pressure mechanism deforming the deformable member and piercing the pierceable member.

2. The reagent holding container according to claim 1, comprising a base member between the deformable member and the pierceable member.

3. The reagent holding container according to claim 1, wherein the deformable member is silicone rubber.

4. The reagent holding container according to claim 3, wherein the silicone rubber has a thickness of from 0.1 to 1.0 mm.

5. The reagent holding container according to claim 1, wherein the pierceable member is an aluminum film.

6. The reagent holding container according to claim 5, wherein the aluminum film has a thickness of 10 to 50 μm.

7. The reagent holding container according to claim 1, wherein the pierceable member is a plastic film of polypropylene, polyimide, polyester, nylon, polycarbonate, or PET.

8. The reagent holding container according to claim 2, comprising a second pierceable member different from the pierceable member, and that is layered on the deformable member.

9. The reagent holding container according to claim 8, wherein the deformable member is in contact with the base member, and is located closer to the reagent contained in the container than the second pierceable member.

10. The reagent holding container according to claim 8, wherein the second pierceable member is in contact with the base member, and is located closer to the reagent contained in the container than the deformable member.

11. The reagent holding container according to claim 1, wherein metal is vapor deposited on the deformable member.

12. The reagent holding container according to claim 2, wherein the base member and the deformable member are bonded to each other with a double-sided tape.

13. The reagent holding container according to claim 2, wherein the base member and the pierceable member are bonded to each other with a double-sided tape.

14. The reagent holding container according to claim 2, wherein the base member and the deformable member are bonded to each other by thermocompression bonding.

15. The reagent holding container according to claim 2, wherein the base member and the pierceable member are bonded to each other by thermocompression bonding.

16. A liquid delivery device comprising:
a reagent holding container;
a reagent holding container receptacle for receiving the reagent holding container;
a pressure mechanism;
a liquid inlet;
a liquid outlet; and
a channel connecting the liquid inlet and the liquid outlet to each other,
wherein the reagent holding container receptacle is connected to a part of the channel, and wherein the reagent holding container includes a deformable member and a pierceable member, and discharges a reagent held therein upon the pressure mechanism deforming the deformable member and piercing the pierceable member.

17. The liquid delivery device according to claim 16, wherein the reagent holding container receptacle has a stopper for holding the reagent holding container.

18. The liquid delivery device according to claim 16, wherein the reagent holding container receptacle has a narrow cross section in a portion connecting to the channel.

19. The liquid delivery device according to claim 16, wherein the channel in a portion connecting to the reagent holding container receptacle has a depression in a direction of applied pressure by the pressure mechanism.

20. The liquid delivery device according to claim 17, wherein the reagent holding container receptacle has a piercing portion projecting toward the reagent holding container held by the stopper.

21. The liquid delivery device according to claim 20, wherein the piercing portion has a hollow space therein, and the hollow space is in communication with the channel.

22. The liquid delivery device according to claim 16, wherein the pressure mechanism is a plunger.

23. A reagent discharge method for discharging a reagent from a reagent holding container that includes a deformable member and a pierceable member,
the method comprising deforming the deformable member and piercing the pierceable member with an external pressure mechanism to discharge the reagent held inside the container.
